(19) United States
(12) Patent Application Publication
(10) Pub. No.: US 2008/0150274 A1
(43) Pub. Date: Jun. 26, 2008

(54) HARDBOUND BOOK CORNER PROTECTOR

(76) Inventor: DAVID R. HIGH, Oklahoma City, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(21) Appl. No.: 11/938,606

(22) Filed: Nov. 12, 2007

Related U.S. Application Data
(60) Provisional application No. 60/858,476, filed on Nov. 13, 2006.

(51) Int. Cl. B42D 3/18; B42D 3/12

(52) U.S. Cl. 281/20; 281/15.1

(57) ABSTRACT

A hardbound book corner protector including a back plate with two intersecting edges; a front guard also including two intersecting edges; and a brace connecting the two intersecting edges of the back plate with the two intersecting edges of the front guard to form a pocket or sleeve to receive a corner of a hardbound book. The back plate has a greater surface area than the front guard. A third edge of the triangular front guard may include an arcuate segment. The corner may be reinforced to provide added strength to the corner protector. The interior surfaces of the back plate and the front guard include a smooth texture so that the corner protector may be adhered to the corner of a hardbound book such that the back plate is adhered to the inside cover and the front guard is adhered to the outside cover.

This application claims the benefit of U.S. Provisional Patent Application Ser. No. 60/858,476, filed on Nov. 13, 2006, the disclosure of which is incorporated herein by reference as if fully set out at this point.

### FIELD OF THE INVENTION

The hardbound book corner protector of the present invention relates, generally, to protective guards and covers for books, and particularly to hardbound books.

### BACKGROUND OF THE INVENTION

The covers of hardbound books are known to fray, bend, or discolor during use of the book. This is particularly true in the case of hardbound textbooks which are typically used in class, stored in a locker or backpack or vehicle, transported and used at home and then transported back to class. This repeated use, transportation, and storage of these hardbound textbooks subjects them to repeated dropping or other such mishandling as well as extensive abuse. The corners of these books are the area of the hardbound book cover that is most susceptible to the damage described above. As a result, many hardbound books are damaged, and particularly textbooks. Such damage shortens the life of the book and diminishes both its current value and its re-sale value. Thus, a need exists for protective corner protectors for hardbound books.

### SUMMARY OF THE INVENTION

The present disclosure relates to a hardbound book corner protector including a back plate with two intersecting edges; a front guard also including two intersecting edges; and a brace connecting the two intersecting edges of the back plate with the two intersecting edges of the front guard to form a pocket or sleeve to receive a corner of a hardbound book. More specifically, a back plate includes a first edge and a second edge such that the first edge and second edge intersect at an intersection. The back plate includes a third edge and a fourth edge such that together with the first and second edges, define a substantially square geometry.

The front guard includes a first edge and a second edge such that the first edge and second edge intersect at an intersection. The front guard also includes a third edge which intersects the first edge and second edge in order to form a substantially triangular geometry in the preferred embodiment.

The brace includes a first brace segment and a second brace segment. The first brace segment connects the first edge of the back plate with the first edge of the front guard. The second brace segment connects the second edge of the back plate with the second edge of the front guard. The intersection formed at the back plate is adjacent to the intersection formed at the front guard so as to form a corner. This corner is approximately 90° so as to mate and receive the corner of a hardbound book within the pocket or sleeve. The corner may be reinforced so as to provide structural rigidity to the corner protector in the event that the book is dropped or struck directly on, or adjacent to, the corner.

The back plate has a greater surface than the front guard. As stated, the back plate includes a substantially square geometry which is not readily visible when the book is closed. Therefore, the large surface area and geometry does not diminish the aesthetics of the corner protector. The greater surface area of the back plate provides a large surface area to affix the corner protector to the inside cover of the book. It also provides a large area of protection to the corner of the book and allows the distribution and transfer of kinetic energy from the corner protector to the book cover in the event the book is dropped where by the cover protector strikes the ground or another object. This large surface area thereby reduces the possibility that the corner protector will become dislodged from the hardbound book cover or that the book cover will bend along the edges of the back plate on the inside cover.

The front guard includes a smaller surface area and different geometry from the back plate such that the stress lines created between the cover protector and the inside and outside of the hardbound book cover do not match. This is in an effort to avoid stress to or bending of the hardbound book cover along those stress lines in the event that the corner is struck or bent. The front guard may also include an arcuate segment on the third edge. This arcuate segment provides an aesthetic aspect to the corner protector but also breaks up an otherwise linear stress line between the front guard and the front cover of the hardbound book. The possibility that the cover of the hardbound book will weaken, be stressed or bend along the third edge of the front guard is thus reduced.

The exterior surfaces of the corner protector may be textured so as to provide desirable characteristics such as, without limitation; glare resistance, tactile properties, and/or resistance to the adhesion properties of glue, chewing gum and/or the like. In addition, the interior surfaces of the back plate and the front guard (which define the pocket) may include a smooth texture so that the corner protector of the present disclosure may be adhered to the corner of the hardbound book with either an adhesive, tape, or other such materials known in the art.

### BRIEF DESCRIPTION OF THE DRAWINGS

FIG. 1 is a front side view of the hardbound book corner protector of the present disclosure.

FIG. 2 is an end view of the hardbound book corner protector of FIG. 1.

FIG. 3 is an opposite or back side view of the hardbound book corner protector of FIG. 1

FIG. 4 is a view of the front guard taken along lines 4-4 of FIG. 2.

FIG. 5 is a partial cutaway view depicting the inside cover including a hardbound book corner protector of the present disclosure affixed to a corner.

FIG. 6 is an isometric view of a hardbound book including exemplary hardbound book corner protectors of the present disclosure affixed thereon.

FIG. 7 is an isometric view of the hardbound book corner protector of the present disclosure.

### DETAILED DESCRIPTION OF THE PREFERRED EMBODIMENTS

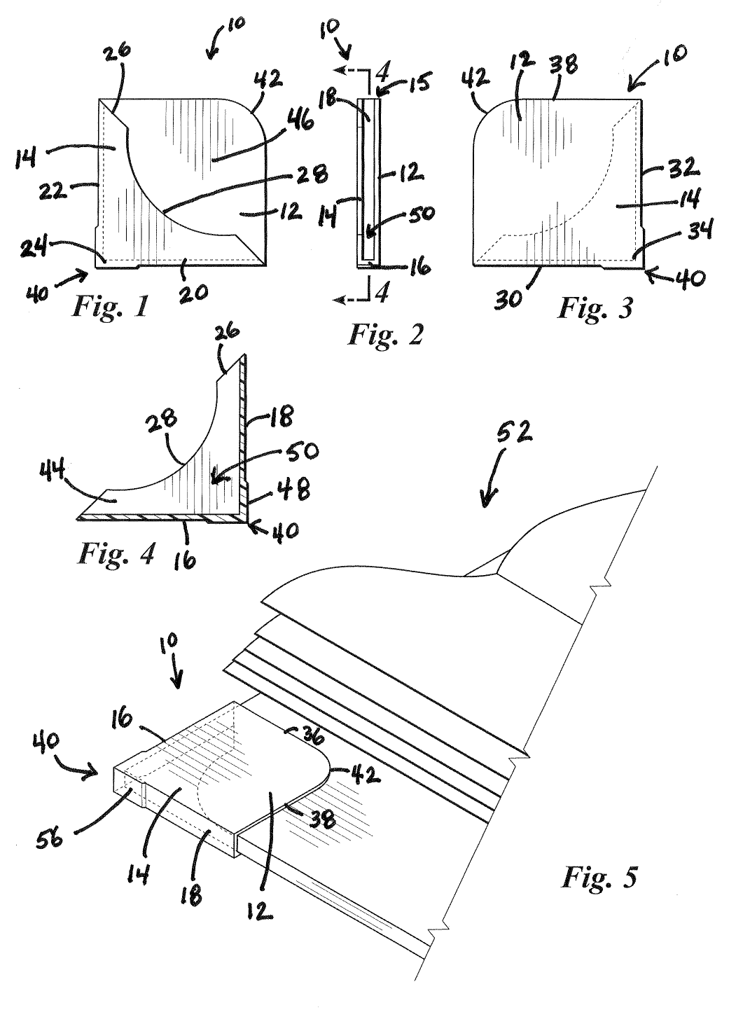

With reference to FIGS. 1-3, and 7, the hardbound book corner protector 10 of the present invention includes a back plate 12 and front guard 14. Front guard 14 (FIG. 1) includes two intersecting edges 20 and 22. First edge 20 and second edge 22 intersect at intersection 24. Front guard 14 also includes a third edge 26 which intersects both first edge 20 and second edge 22 such that edges 20, 22, and 26 define a substantially triangular geometry. Front guard 14 may also include an arcuate segment 28 as shall be discussed further below.

Back plate 12 (FIG. 3) also includes two intersecting edges. First edge 30 and second edge 32 intersect at an intersection 34. In the preferred embodiment, back plate 12 and two additional edges 36 and 38, together with edges 30 and 32, define a substantially square geometry. In a the preferred embodiment, corner 42 of back plate 12 is rounded, the purpose of which shall be discussed in greater detail below.

The two intersecting edges 20 and 22 of the front guard 14 are connected to the two intersecting edges 30 and 32 of the back plate 12 by a brace 15 (FIG. 2). Brace 15 includes a first brace segment 16 and a second brace segment 18. First brace segment 16 connects first edge 20 of front guard 14 to first edge 30 of back plate 12. Second brace segment 18 connects second edge 22 of front guard 14 to second edge 32 of back plate 12.

The connection of front guard 14 to back plate 12 through brace 15 thus forms a pocket 50 (FIG. 7) capable of receiving the corner of a hard cover on a hardbound book. The width of brace 15 is preferably just larger than the width of a standard hard cover of a hardbound book, known in the industry to be approximately one-eight inch (⅛″) such that when corner protector 10 is placed on the corner of a hard cover of a hardbound book (such as shown in FIG. 5), corner protector 10 fits securely on the corner of the hard cover of the hardbound book. In the preferred arrangement, corner protector 10 is a solid injection molded piece of polypropylene, due to its high tensile strength. Moreover, corner protector 10 may be dyed any desired color such as to match the color of the hard cover of a hardbound book. However, it is understood by one of skill in the art that other suitable materials (such as high density polyethylene), constructions, and manufacturing processes could be substituted.

In the preferred embodiment, the corner 40 which covers the corner 56 of the hard cover 54 of a hardbound book 52 (FIG. 5) is reinforced with a thicker amount of molded material so as to provide additional structural rigidity to corner protector 10 so as to protect the corner 56 of hardbound book 52.

FIG. 4 is a view of the front guard taken along line 4-4 of FIG. 2 and depicts a cutaway view of the front guard of the pocket 50 of the corner protector of the present disclosure. FIG. 4 depicts the preferred construction of the reinforced area of thickened material 48 of corner 40.

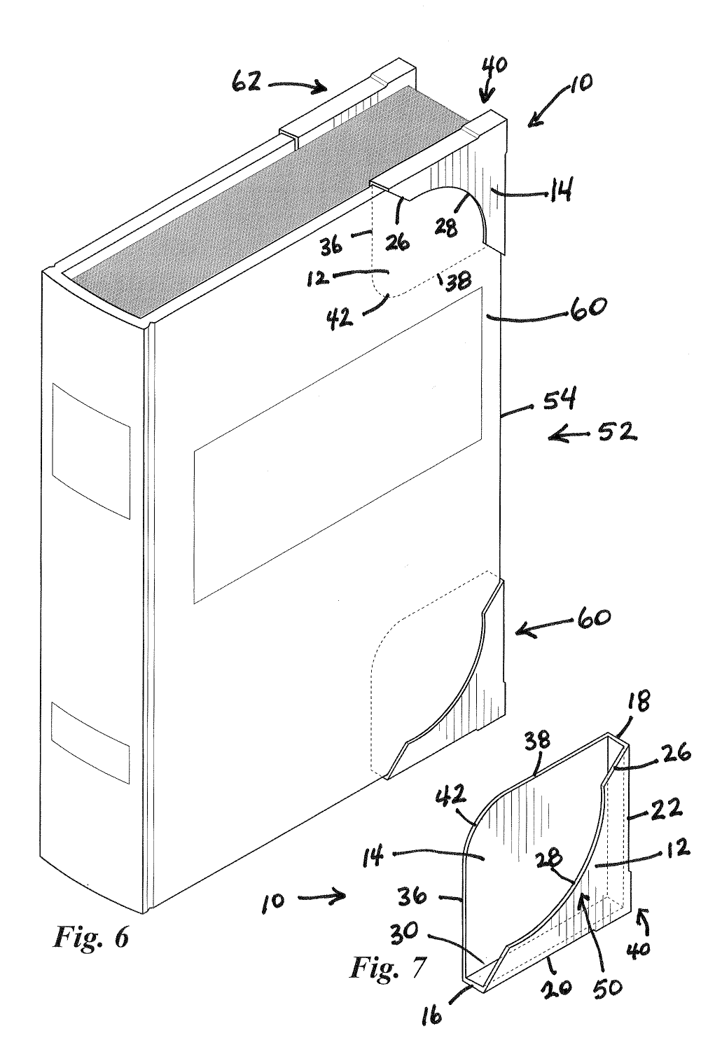

Referring next to FIG. 5 in combination with FIG. 6, a corner protector 10 of the present disclosure is depicted affixed onto the corner 56 of the hard cover 54 of an exemplary book 52. As depicted, corner protector 10 is preferably affixed to corner 56 of hardbound book cover 54 with back plate 12 adjacent and affixed to inside cover 58 and front guard 14 affixed and adjacent to outside front cover 60. Back plate 12 is of a substantially square geometry and has a greater surface area than front guard 14. The reason for this is so that back plate 12 provides a large surface area to affix to inside cover 58. This greater surface area of back plate 12 allows corner protector 10 to be securely affixed to cover 54. The large surface area of back plate 12 also allows a large transfer surface for kinetic energy between corner protector 10 and hard cover 54. This is significant in the event that book 52 is dropped so that corner 40 of corner protector 10 strikes the ground or another object. It also acts to reduce the possibility of dislodging corner protector 10 from hard cover 54.

As stated above, the area of increased thickness 48 of corner 40 also provides additional structural rigidity to corner protector 10 in the event that book 52 is dropped or struck on corner 40. Back plate 12 also includes in a preferred embodiment a rounding corner 42. Corner 42 of back plate 12 is preferably rounded so as to reduce the possibility that corner 42 may get snagged on an object unintentionally being inserted between back plate 12 and inside cover 58 thereby tearing book plate 12 from inside cover 58. Corner 42 is also rounded so as to reduce the linear stress lines that back plate 12 may apply to inside cover 58 of hard cover 54 in the event that cover protector 10 or corner 40 is bent, torqued, or otherwise stressed in order to avoid bending of hard cover 54 along edges 36 and 38.

In like manner, back plate 12 has a larger surface area than front guard 14 such that, if a force is applied to corner 40, there will not be equal stresses placed upon inside cover 58 at edges 36 and 38 and front cover 60 by edge 26 which might otherwise increase the possibility of creasing hard cover 54 such as if the edges of front guard 14 were aligned with the edges of back plate 12.

Edge 26 of front guard 14 includes an arcuate segment 28 in the preferred embodiment. Arcuate segment 28 provides an aesthetically pleasing contour to edge 26 of front guard 14 but also provides a nonlinear edge 26. Since edge 26 is not linear, a stress line on front cover 60 is avoided, again in the event book 52 is dropped or hard cover 54 is somehow bent at corner 40 or anywhere along corner protector 10. In addition, arcuate segment 28, since it presents a non-linear edge, reduces the possibility that objects, including without limitation, fingernails, paper, bookmarks, writing instruments and the like will snag on third edge 26 of front guard 14. Thus, a corner protector for a hardbound book is defined.

Corner protector 10 is affixed to corner 56 of hard cover 54 of hardbound book 52 through a friction fit created by the dimensions of pocket 50 of corner protector 10 but is also preferably adhered using glue, double-sided tape, or any other known method. This is done by applying either adhesive or a segment (preferably about two inches) of tape to the inside cover 58 at corner 56 and a much smaller size segment of tape to the outside of the cover 60. Corner protector 10 is then inserted onto corner 56 such that back plate 12 is adjacent inside cover 58 and front guard 14 is adjacent front cover 60.

With reference to FIG. 6, corner protector 10 is depicted affixed onto hard cover 54 of book 52. It is contemplated that additional corner protectors 61, 62, and 64 (not shown) would be affixed to the other three corners of hard cover 54 of book 52. Corner protectors 61, 62, and 64 are of an identical design to corner protector 10.

Thus, the present invention is well adapted to carry out the objectives and attain the ends and advantages mentioned above as well as those inherent therein. While presently preferred embodiments have been described for purposes of this disclosure, numerous changes and modifications will be apparent to those of ordinary skill in the art. Such changes and modifications are encompassed within the spirit of this invention as defined by the claims.

What is claimed is:

1. A corner protector for a hardbound book comprising:
a back plate including two intersecting edges and a surface area;
a front guard including two intersecting edges and a surface area;
a brace connecting said two intersecting edges of said back plate to said two intersecting edges of said front guard so as to form a pocket to receive a corner of a hardbound book;
said surface area of said back plate being greater than said surface area of said front guard.

2. The corner protector of claim 1 wherein said front guard includes a third edge which intersects each of said two intersecting edges such that said front guard defines a substantially triangular geometry.

3. The corner protector of claim 2 wherein said third edge includes an arcuate segment.

4. The corner protector of claim 1 wherein said two intersecting edges of said back plate and said two intersecting edges of said front guard connected by said brace define a corner wherein said corner in reinforced.

5. The corner protector of claim 1 wherein said back plate includes a substantially square geometry.

6. The corner protector of claim 5 wherein said two intersecting edges of said back plate form one corner of said square having four corners and the corner opposite said one corner is rounded.

7. The corner protector of claim 1 wherein said pocket comprises surfaces which include a smooth texture which facilitate adhering the corner protector to a corner of the hardbound book.

8. A corner protector for a hardbound book comprising:
a back plate including a surface area and at least a first edge and a second edge wherein said first edge and said second edge intersect at an intersection;
a front guard including a surface area and at least a first edge and a second edge wherein said first edge and said second edge intersect at an intersection;
a first brace connecting said first edge of said back plate with said first edge of said front guard; and
a second brace connecting said second edge of said back plate with said second edge of said front guard;
such that said intersections form a corner;
said corner being reinforced; and
said surface area of said back plate being greater than said surface area of said front guard.

9. The corner protector of claim 8 wherein said corner substantially defines a right angle.

10. The corner protector of claim 9 wherein said front guard includes a third edge which intersects each of said two intersecting edges such that said front guard defines a substantially triangular geometry.

11. The corner protector of claim 10 wherein said third edge includes an arcuate segment.

12. The corner protector of claim 8 wherein said back plate includes a substantially square geometry.

13. The corner protector of claim 8 wherein said back plate and said front guard include inside surfaces comprising a smooth texture to facilitate adhering the corner protector to a corner of the hardbound book.

14. The corner protector of claim 8 wherein said back plate, front guard, first brace segment, and second brace segment include exterior surfaces wherein said exterior surfaces are textured.

15. The corner protector of claim 1 wherein said back plate, front guard and brace include exterior surfaces wherein said exterior surfaces are textured.
